(19) United States
(12) Patent Application Publication
(10) Pub. No.: US 2024/0246201 A1
(43) Pub. Date: Jul. 25, 2024

(54) HYDRAULIC TORQUE WRENCH

(71) Applicant: Enerpac Tool Group Corp., Menomonee Falls, WI (US)

(72) Inventors: Kyle Michael Harvey, Waukesha, WI (US); Connor Joseph Sannito, Sturgeon Bay, WI (US); Eric Norquist, Whitefish Bay, WI (US)

(73) Assignee: Enerpac Tool Group Corp., Menomonee Falls, WI (US)

(21) Appl. No.: 18/561,421

(22) PCT Filed: Jun. 29, 2022
(86) PCT No.: PCT/US2022/035536

§ 371 Date: Nov. 16, 2023

Related U.S. Application Data
(60) Provisional application No. 63/216,256, filed on Jun. 29, 2021.

(51) Int. Cl. B25B 21/00

(52) U.S. Cl. CPC B25B 21/005

(57) ABSTRACT

A hydraulic tool, a hydraulic torque wrench, and a method of operating a hydraulic tool. The hydraulic torque wrench may generally include a housing; a motor positioned in the housing; a battery pack supported on the housing and operable to supply power to the motor, a drive mechanism including a cylinder, a piston movably supported in the cylinder, a pump supported by the housing, powered by the motor, and operable to transfer hydraulic fluid to the cylinder to move the piston, and a driver attached to the piston and movable therewith between a retracted position and an extended position; and a drive element coupled to the driver, the driver being configured to transmit torque through the drive element.

### RELATED APPLICATION

This application claims priority to U.S. Provisional Patent Application No. 63/216,256, filed on Jun. 29, 2021, the entire contents of which are hereby incorporated by reference.

### FIELD

The present disclosure relates to hydraulic tools and, more particularly, to a battery-powered hydraulic tool, such as a torque wrench, a flange splitter, etc.

### SUMMARY

Hydraulic tools, such as hydraulic torque wrenches, flange splitters, etc., use pressurized fluid to apply large forces (e.g., torque forces to a fastener, a nut, etc.). In particular, application of the pressurized fluid to a piston drives a tool element (e.g., a socket to rotate in a first direction).

A hydraulic torque wrench is usually driven by a separate motor-driven pump supplying hydraulic fluid through a hose connected to the wrench. The separate pump requires two operators to perform a bolting operation—one to operate the pump, and the other to hold the wrench. Also, the operator is required to transport the pump, hoses, etc. to/from and around a work site. Additionally, access to electrical power or hydraulics is required to drive the pump and thereby the separate torque wrench.

In one independent aspect, a hydraulic torque wrench may generally include a housing; a motor positioned in the housing; a battery pack supported on the housing and operable to supply power to the motor; a cylinder; a piston movably supported in the cylinder; a pump supported by the housing, powered by the motor, and operable to transfer hydraulic fluid to the cylinder to move the piston; a driver attached to the piston and movable therewith between a retracted position and an extended position; and a cassette removably coupled to the housing and including a drive element coupled to the driver, the driver being configured to transmit torque through the drive element.

In another independent aspect, a hydraulic tool may generally include a housing having a first end and a second end, the housing including a motor housing portion positioned on the first end and providing a first grip engageable by a hand of an operator and defining a first grip axis, and a handle engageable by another hand of the operator and defining a second grip axis obliquely oriented relative to the first grip axis; a piston and cylinder assembly; a pump supported by the housing and operable to transfer hydraulic fluid to the piston and cylinder assembly; a motor positioned in the motor housing portion and configured to drive the pump; and a tool element coupled to the housing and including a drive element coupled to the piston and cylinder assembly, the piston and cylinder assembly being configured to transmit torque through the drive element.

In yet another independent aspect, a hydraulic tool may generally include a housing having a first end, a second end, and a longitudinal axis extending through the first end and the second end, the housing including a handle engageable by a hand of an operator and defining a grip axis obliquely oriented relative to the longitudinal axis, and a battery pack support portion proximate the second end; a battery pack supported on the battery pack support portion along a battery insertion axis the battery insertion axis being obliquely oriented relative to the longitudinal axis and the grip axis; a piston and cylinder assembly; a pump supported by the housing and operable to transfer hydraulic fluid to the piston and cylinder assembly; a motor positioned adjacent the first end and configured to drive the pump; and a tool element coupled to the housing and including a drive element coupled to the piston and cylinder assembly, the piston and cylinder assembly being configured to transmit torque through the drive element.

In a further independent aspect, a method of operating a hydraulic tool may be provided. The tool may include a housing providing a handle engageable by an operator, a power source supported by the housing, a motor positioned in the housing and powered by the power source, a pump positioned in the housing and driven by the motor, a piston and cylinder assembly, and a tool element including a drive element. The method may generally include supporting the tool element on the housing; with the tool element supported on the housing, engaging the tool element with a workpiece, and operating the pump to transfer hydraulic fluid to the piston and cylinder assembly to thereby transmit force through the drive element to the workpiece; disengaging the tool element from the housing; and, with the tool element disengaged from the housing, engaging the tool element with a workpiece, and operating the pump to transfer hydraulic fluid to the piston and cylinder assembly to thereby transmit force through the drive element to the workpiece.

In another independent aspect, a method of operating a hydraulic torque wrench may be provided. The torque wrench may include a housing providing a handle engageable by an operator, a power source supported by the housing, a motor positioned in the housing and powered by the power source, a pump positioned in the housing and driven by the motor, and a hydraulic drive assembly including a piston and cylinder assembly and a tool element including a drive element. The method may generally include supporting the hydraulic drive assembly on the housing in a first orientation; with the hydraulic drive assembly in the first orientation, engaging the tool element with a workpiece, and operating the pump to transfer hydraulic fluid to the piston and cylinder assembly to thereby transmit torque through the drive element in a first direction to the workpiece; supporting the hydraulic drive assembly on the housing in a different second orientation; and with the hydraulic drive assembly in the second orientation, engaging the tool element with a workpiece, and operating the pump to transfer hydraulic fluid to the piston and cylinder assembly to thereby transmit force through the drive element in an opposite second direction to the workpiece.

In yet another independent aspect, a hydraulic torque wrench may generally include a housing including a handle portion engageable by an operator; an output shaft rotatably supported by the housing; a battery pack supported on the housing; a gear drive mechanism including an electric motor supported by the housing and powered by the battery pack, and a gearbox supported by the housing and driven by the motor to selectively rotatably drive the output shaft up to a first torque; and a hydraulic drive mechanism including a motor-driven pump supported by the housing, a piston-cylinder assembly including a cylinder, and a piston movably supported in the cylinder, the pump being operable to transfer hydraulic fluid to the cylinder to move the piston, a lever arm attached to the piston and movable therewith between a retracted position and an extended position, and a drive shoe selectively driven by the lever arm to selectively rotatably drive the output shaft above the first torque.

Other independent aspects of the disclosure may become apparent by consideration of the detailed description, claims and accompanying drawings.

### BRIEF DESCRIPTION OF THE DRAWINGS

FIG. 1 is a perspective view of a hydraulic torque wrench.

FIG. 2 is a cross-sectional view of the hydraulic torque wrench of FIG. 1.

FIG. 3 is a perspective view of the hydraulic torque wrench of FIG. 1, with a battery pack and a tool element removed.

FIG. 4 is another perspective view of the hydraulic torque wrench as shown in FIG. 3.

FIG. 5 is a perspective view of the hydraulic torque wrench of FIG. 1, illustrated on a flange.

FIG. 6A is a perspective view of a portion of the power unit for driving the tool element of the hydraulic torque wrench of FIG. 1.

FIG. 6B is a schematic diagram of the hydraulic drive mechanism shown in FIG. 6A.

FIG. 7A is a perspective view of an alternative construction of a portion of the power unit for driving the tool element of the hydraulic torque wrench of FIG. 1.

FIG. 7B is a schematic diagram of the hydraulic drive mechanism shown in FIG. 7A.

FIG. 8A is a perspective view of another alternative construction of a portion of the power unit for driving the tool element of the hydraulic torque wrench of FIG. 1.

FIG. 8B is a schematic diagram of the hydraulic drive mechanism shown in FIG. 8A.

FIG. 9A is a perspective view of yet another alternative construction of a portion of the power unit for driving the tool element of the hydraulic torque wrench of FIG. 1.

FIG. 9B is a schematic diagram of the hydraulic drive mechanism shown in FIG. 9A.

FIG. 10 illustrates various power tools, with a hydraulic drive mechanism of the hydraulic torque wrench of FIG. 1.

FIG. 11 includes various perspective views of the hydraulic torque wrench of FIG. 1.

FIGS. 12A-12C are perspective views of the hydraulic torque wrench of FIG. 1, including a supplemental handle.

FIG. 13 is a perspective view of the hydraulic torque wrench of FIG. 1, including another supplemental handle.

FIG. 14 includes various views of the hydraulic torque wrench of FIG. 1, illustrating a control panel.

FIG. 15 is a side view of the hydraulic torque wrench of FIG. 1, illustrated on a flange.

FIG. 16 is a photograph of the hydraulic wrench of FIG. 1, illustrated on a flange and with an operator's hand on the handle portion.

FIG. 17 is another photograph of the hydraulic wrench shown in FIG. 16, illustrating the operator's other hand on a gripping surface.

FIG. 18 is another photograph of the hydraulic wrench shown in FIG. 16, illustrating the operator's other hand in another orientation on the gripping surface.

FIGS. 19A-19B are views of a cassette for use with the torque wrench of FIG. 1.

FIGS. 20A-20C are views of an alternative construction of a hydraulic torque wrench, illustrating use of the hydraulic torque wrench.

FIG. 21 is a perspective view of another alternative construction of a hydraulic torque wrench.

FIGS. 22A-22B are perspective views of yet another alternative construction of a hydraulic torque wrench, illustrating use of the hydraulic torque wrench.

FIG. 23 is a perspective view of a further alternative construction of a hydraulic torque wrench.

FIG. 24 is a perspective view of another alternative construction of a hydraulic torque wrench, illustrating use of the hydraulic torque wrench.

FIG. 25 is a perspective view of yet another alternative construction of a hydraulic torque wrench, illustrating use of the hydraulic torque wrench.

### DETAILED DESCRIPTION

Before any independent embodiments are explained in detail, it is to be understood that the disclosure is not limited in its application to the details of construction and the arrangement of components set forth in the following description or illustrated in the following drawings. The disclosure is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10% or more) of an indicated value.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

The embodiment(s) described below and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

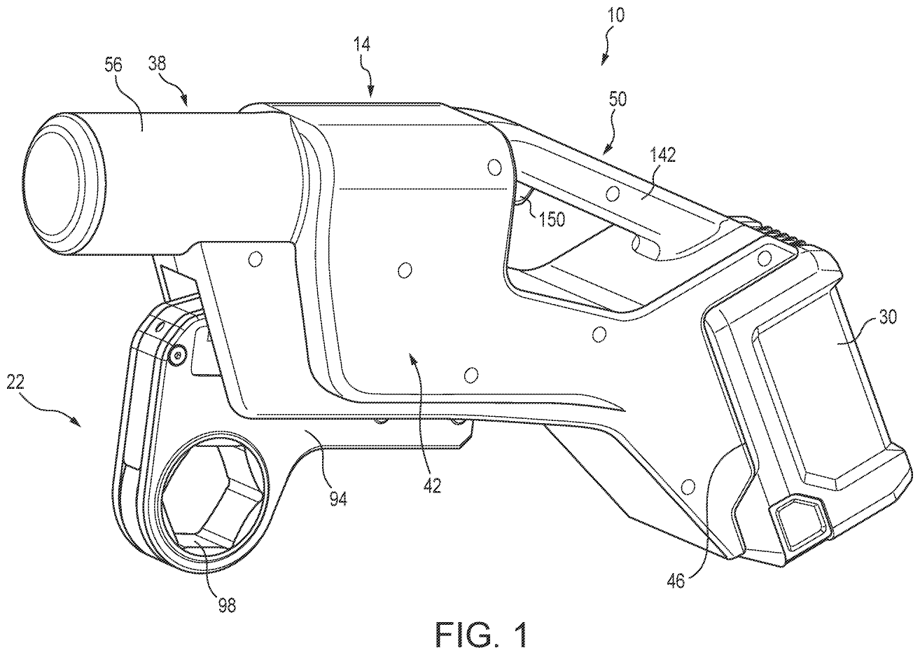

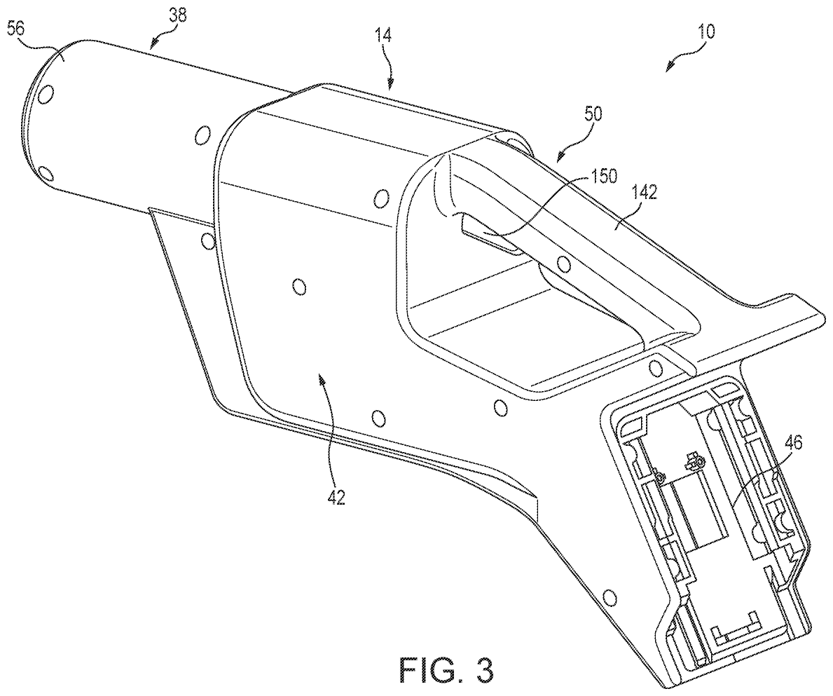

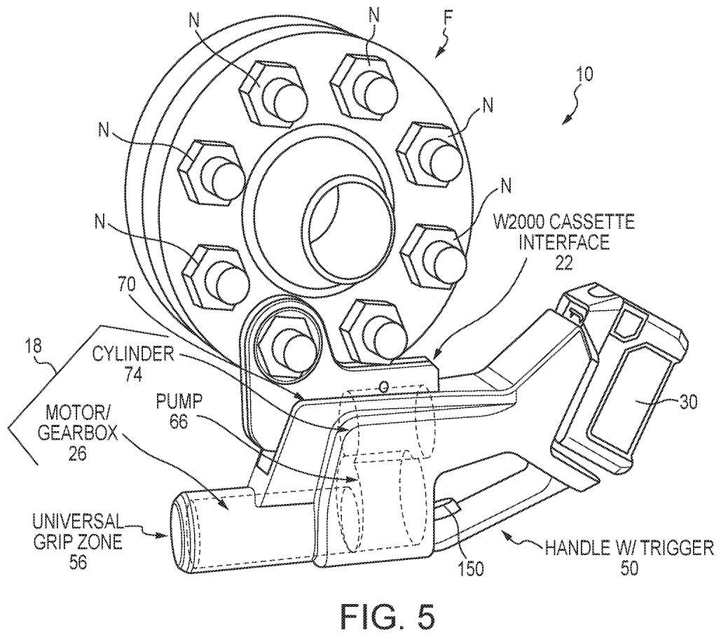

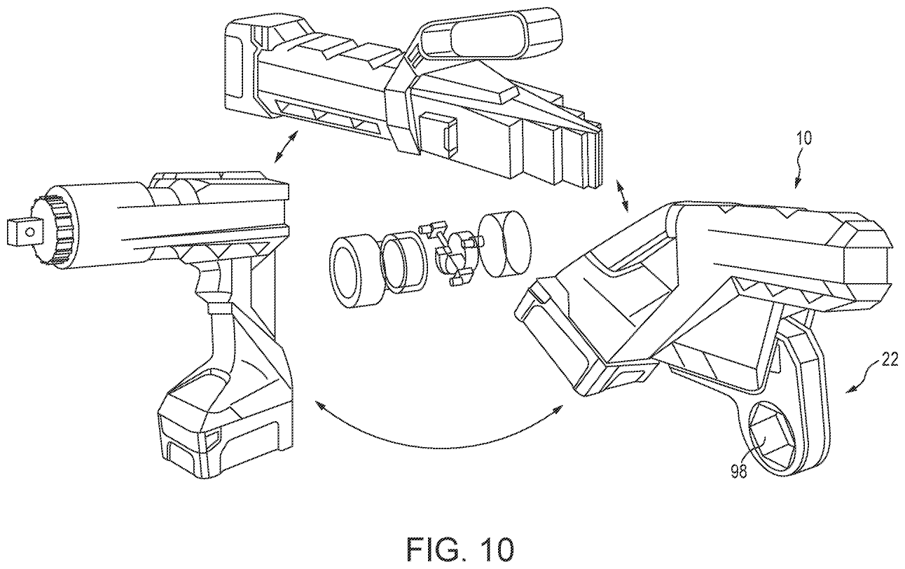

FIGS. 1-5 illustrate a hydraulic tool, such as a hydraulic torque wrench 10 for applying torque to a fastener (e.g., a bolt, a nut N (as shown in FIG. 5), etc.). In other constructions (see, e.g., FIG. 10), the tool may be a different type of tool, such as a flange splitting or spreading wedge, etc., operable to perform another operation on a workpiece (e.g., split or spread apart mated flanges). The illustrated torque wrench 10 generally includes a housing 14, and, supported by the housing 14, a hydraulic drive mechanism 18 for driving a tool element 22, a motor 26 for powering the drive mechanism 18, and a power source (e.g., a battery pack 30) to power the motor 26. The hydraulic drive mechanism 18, the motor 26, and the power source provide a power unit for the tool element 22.

The housing 14 has a first end 14a, a second end 14b, and a longitudinal axis 34 extending through the ends 14a, 14b. The housing 14 generally includes a motor housing portion 38, a drive mechanism portion 42, a battery pack interface 46, a handle portion 50 configured to be gripped by an operator to control operation of the torque wrench 10, and a tool element interface 54.

With reference to FIGS. 1-5, the illustrated motor housing portion 38 is adjacent the first end 14a of the housing 14 and supports the motor 26. In the illustrated construction, the motor 26 is an electric motor; however, in other constructions (not shown), a different type of motor may be provided.

The motor housing portion 38 is generally cylindrical and defines a gripping surface 56 sized and shaped to be graspable by an operator. The gripping surface 56 defines a first grip axis 60 offset from and parallel to the longitudinal axis 34.

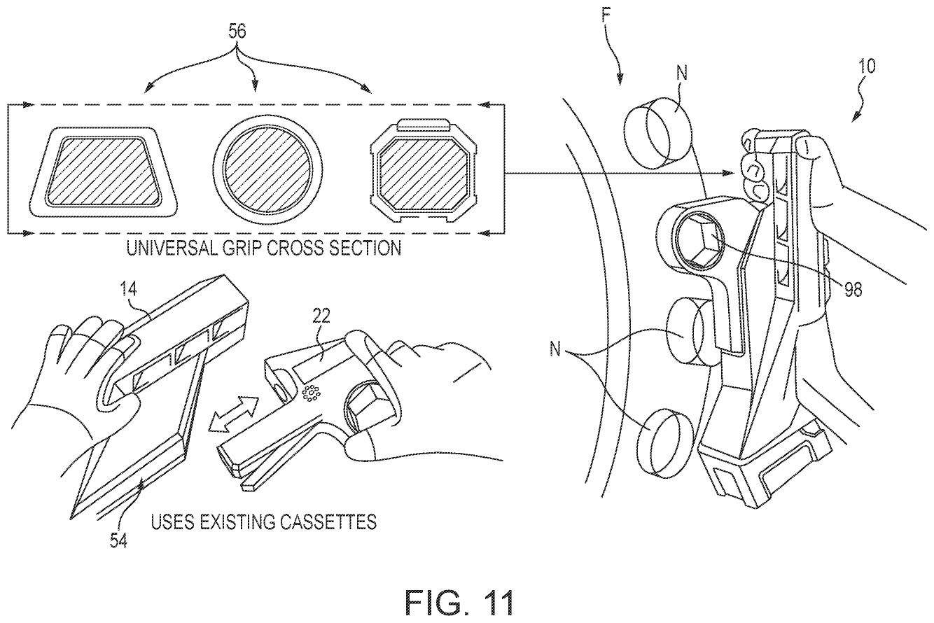

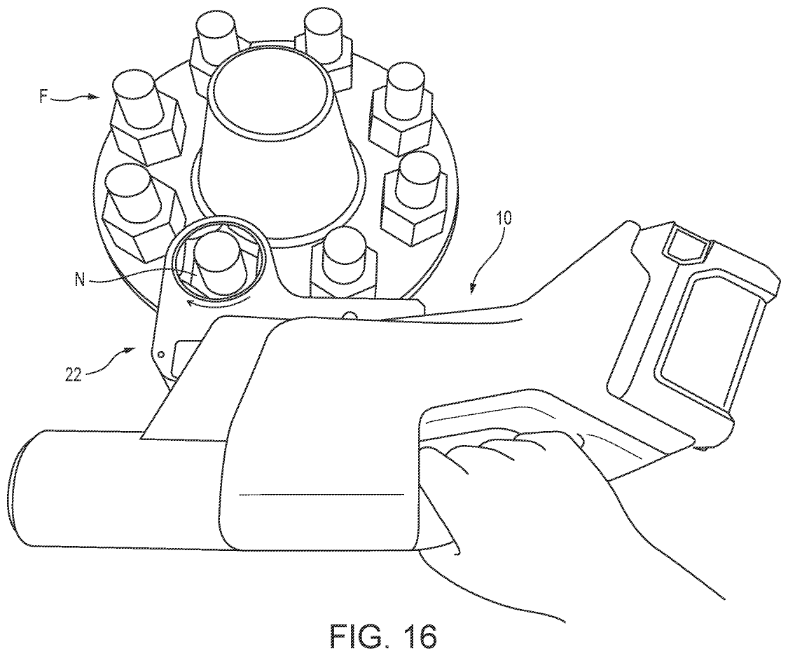

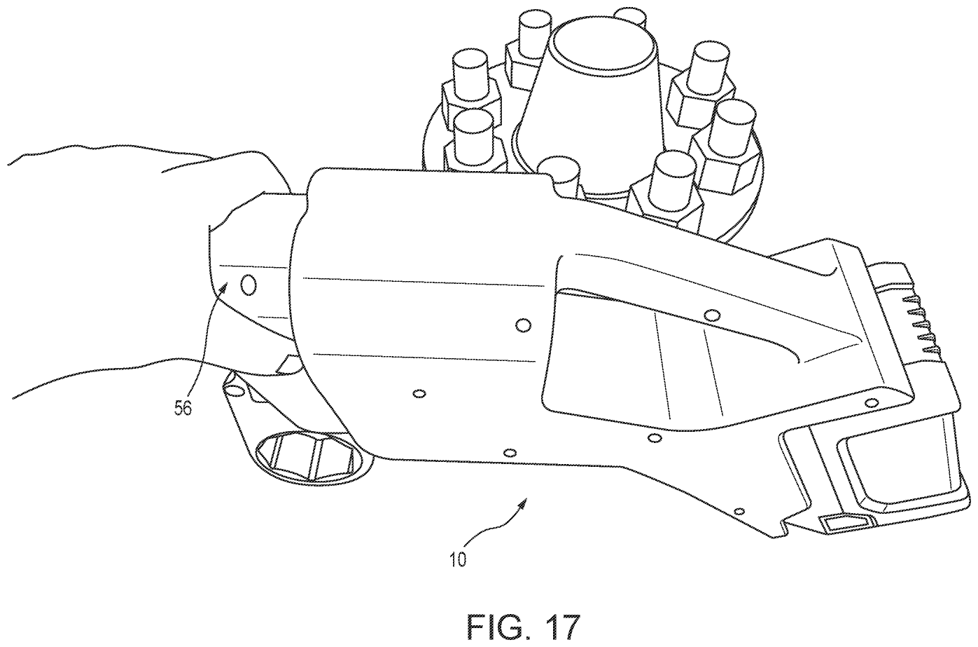

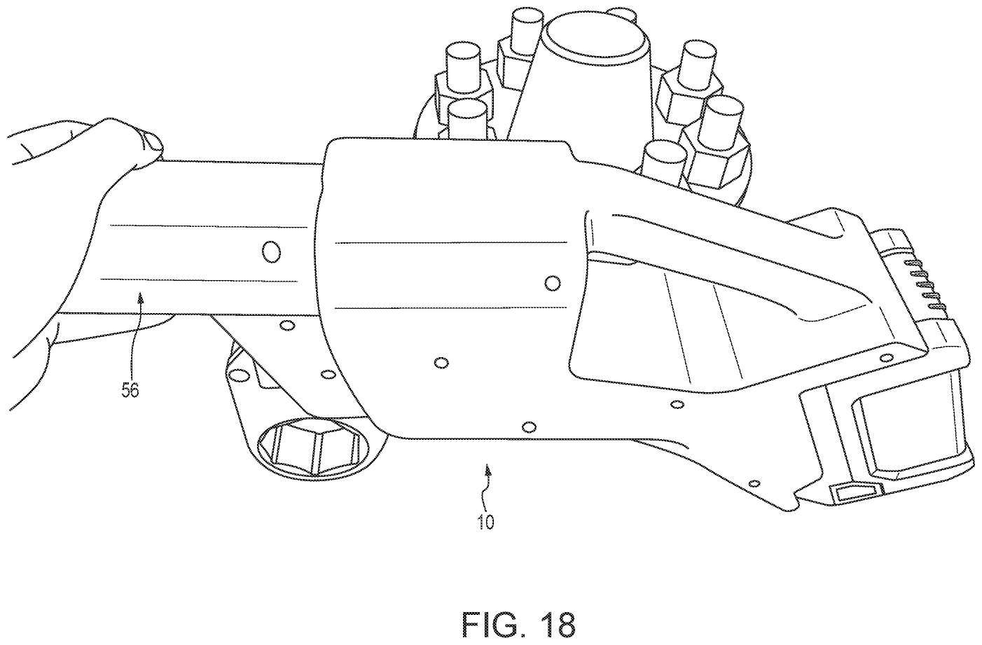

The gripping surface 56 is constructed to be “universal”, meaning that it can be gripped by the operator in any orientation of the torque wrench 10 relative to a work piece (e.g., on each fastener on the flange F, as shown in FIGS. 5 and 15-16). In other embodiments (see FIG. 11), the motor housing portion 38 and the gripping surface 56 may have a different shape (e.g., rectangular, trapezoidal, etc.), size, etc.

As shown in FIGS. 1-5, the drive mechanism portion 42 of the housing 14 supports the drive mechanism 18. The illustrated drive mechanism portion 42 is between the motor housing portion 38 and the handle portion 50.

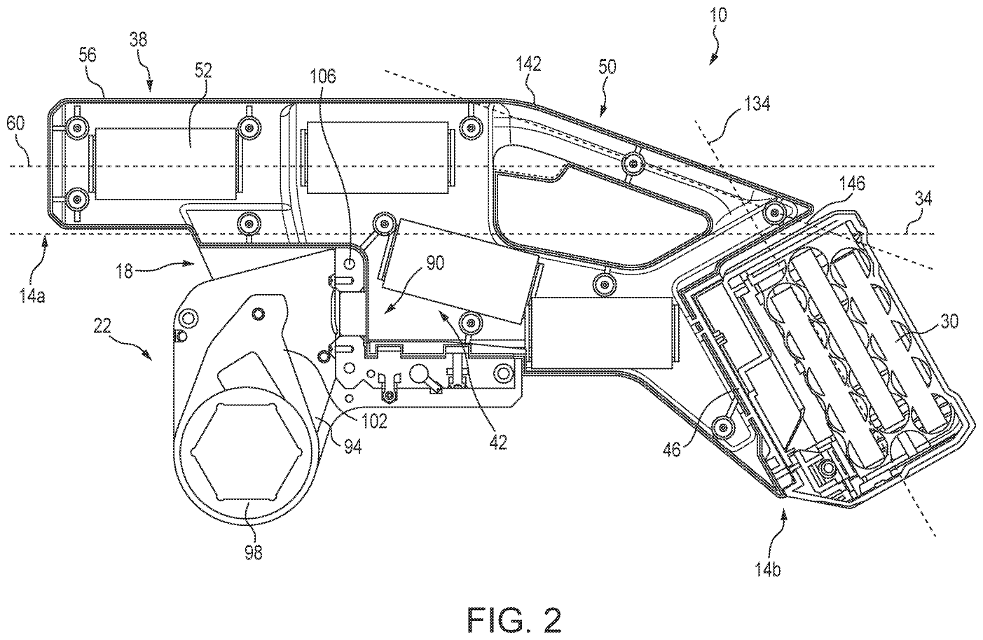

With reference to FIGS. 2 and 5, the hydraulic drive mechanism 18 includes a pump 66 driven by the motor 26 and a piston and cylinder assembly 70. The illustrated drive mechanism 18 is a micro-hydraulic drive mechanism (e.g., with components having a nominal width up to about 3 mm, a flow rate of up to about 20 l/min, and a pressure output of up to about 300 bar or more (e.g., up to 700 bar for the illustrated torque wrench 10).

The piston and cylinder assembly 70 includes a cylinder 74, an extensible piston 78 disposed within the cylinder 74, and a driver 82 attached to the piston 78 and coupled to the tool element 22. The pump 66 provides pressurized hydraulic fluid to the cylinder 74, causing the piston 78 and the driver 82 to reciprocate relative to the cylinder 74. Specifically, the piston 78 (and the driver 82) are movable between an extended position and a retracted position relative to the cylinder 74 as a result of pressurized fluid supplied by the pump 66.

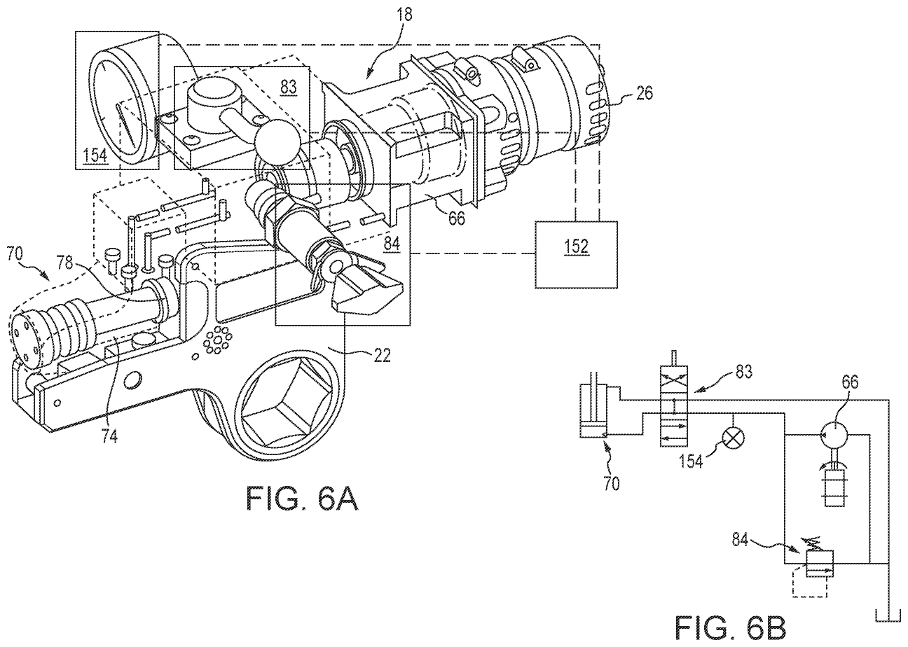

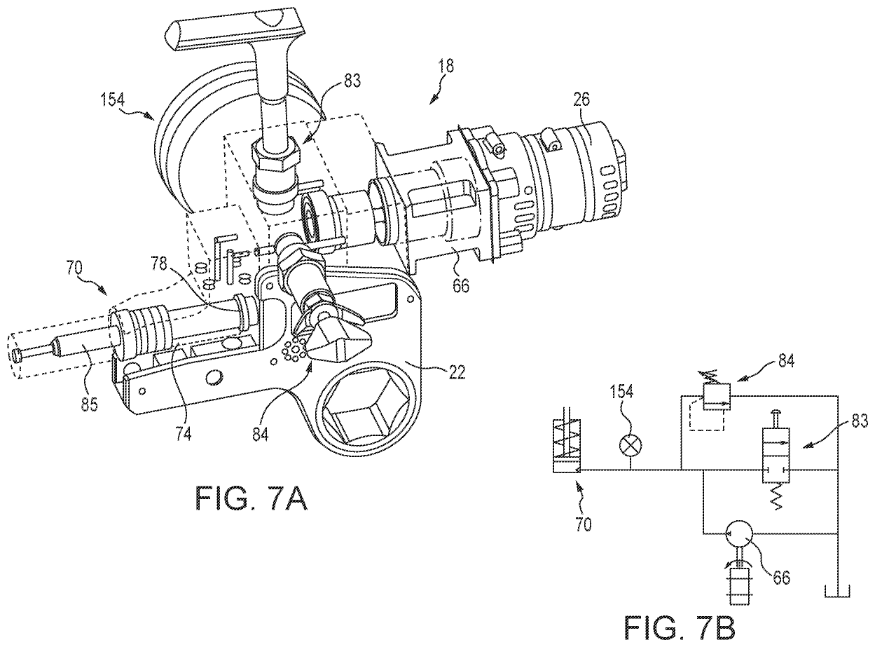

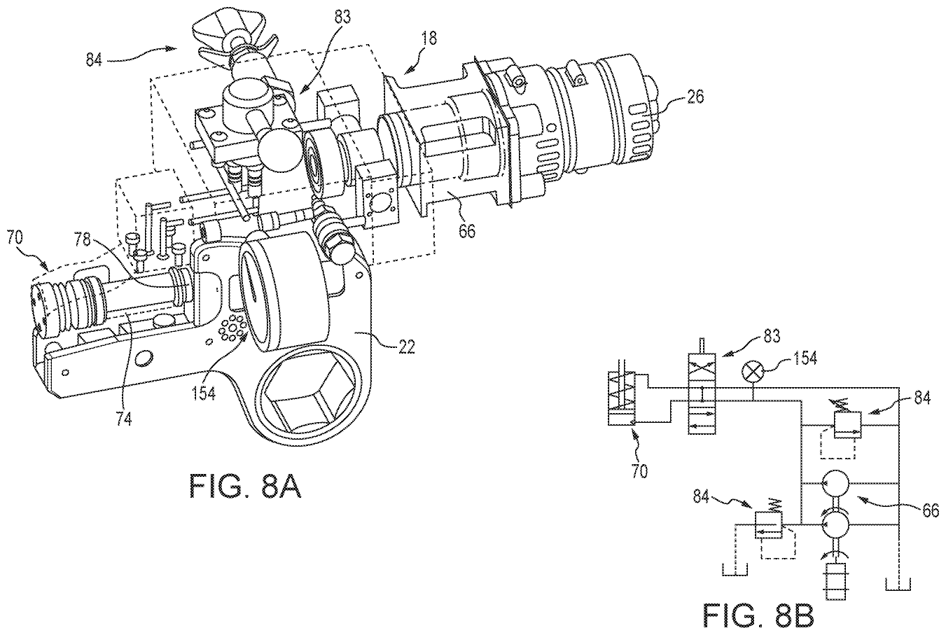

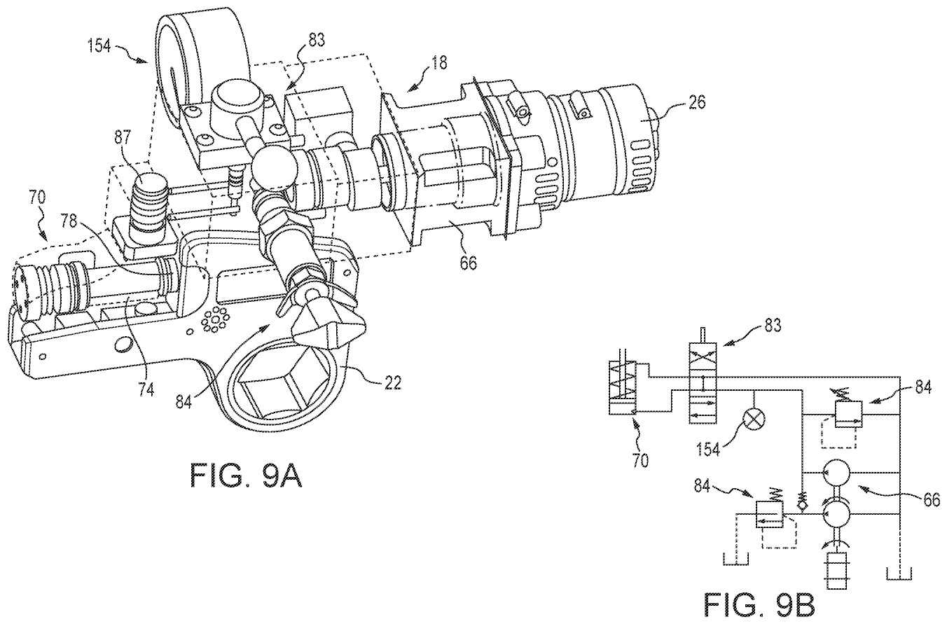

FIGS. 6A-9B illustrate alternative constructions of the power unit for the torque wrench 10. In general, constructions of the power unit may include a single-acting (see FIG. 7A) or double-acting (see FIGS. 6A, 8A, 9A) cylinder assembly 70. The connection between the pump 66 and the cylinder assembly 70 may be stationary or fixed (see FIGS. 6A-8A) or movable (e.g., pivoting or swiveling (see FIG. 9A)). The pump 66 may be a single stage (see FIGS. 6A-7A) or multi-stage (e.g., two stage (see FIGS. 8A-9A)) pump.

As shown in FIGS. 6A-6B, the pump 66 is a single stage pump. The cylinder assembly 70 is a double-acting cylinder assembly, with hydraulic fluid causing movement of the piston 78 in both directions. In the illustrated construction, the connection between the pump 66 and the cylinder assembly 70 is stationary.

A control valve 83 controls flow of hydraulic fluid to the cylinder assembly 70. With the double-acting cylinder assembly 70, the illustrated control valve 83 includes a 4-way, 3-position valve. In other constructions (not shown), the control valve 83 may include a 4-way, 2-position valve. An operator adjustable relief valve 84 is operable to control or set the maximum pressure in the hydraulic circuit.

As shown in FIGS. 7A-7B, the pump 66 is a single stage pump. The cylinder assembly 70 is a single-acting cylinder assembly, with hydraulic fluid causing movement of the piston 78 in one direction (e.g., the driving direction) to the extended position. A spring member 85 causes movement of the piston 78 in the other direction (e.g., the return direction) to the initial, retracted position. In the illustrated construction, the connection between the pump 66 and the cylinder assembly 70 is stationary. With the single-acting cylinder assembly 70, the illustrated control valve 83 includes a 2-way, 2-position valve.

As shown in FIGS. 8A-8B, the pump 66 is a two-stage pump. The cylinder assembly 70 is a double-acting cylinder assembly, and, in the illustrated construction, the connection between the pump 66 and the cylinder assembly 70 is stationary. With the double-acting cylinder assembly 70, the illustrated control valve 83 includes a 4-way, 3-position valve but, in other constructions (not shown), may include a 4-way, 2-position valve. With the high flow pump, an additional loading valve 86 is included in the hydraulic circuit.

As shown in FIGS. 9A-9B, the pump 66 is a two-stage pump, and the cylinder assembly 70 is a double-acting cylinder assembly. With the double-acting cylinder assembly 70, the illustrated control valve 83 includes a 4-way, 3-position valve but, in other constructions (not shown), may include a 4-way, 2-position valve. With the high flow pump, the additional loading valve 86 is included.

In the illustrated construction, the connection between the pump 66 and the cylinder assembly 70 is movable (e.g., pivoting or swiveling). A swivel connector 87 fluidly connects the pump 66 to the cylinder assembly 70 and mechanically connects the cylinder assembly 70 and the tool element 22 to the housing 14.

With this movable arrangement, the orientation of the tool element 22 relative to the housing 14 may be adjusted between a first position, in which the axis of the cylinder assembly 70 is parallel to (see FIG. 10A) or coaxial with (not shown) the axis of the motor 26 and/or the pump 66, and a second position (not shown), in which the axis of the cylinder assembly is misaligned relative to the axis of the motor 26 and/or of the pump 66. For example, in the second position, the axis of the cylinder assembly 70 may be substantially perpendicular to the axis of the motor 26 and/or of the pump 66 and the axis of the tool element 22 may be parallel to or coaxial with the axis of the motor 26 and/or of the pump 66.

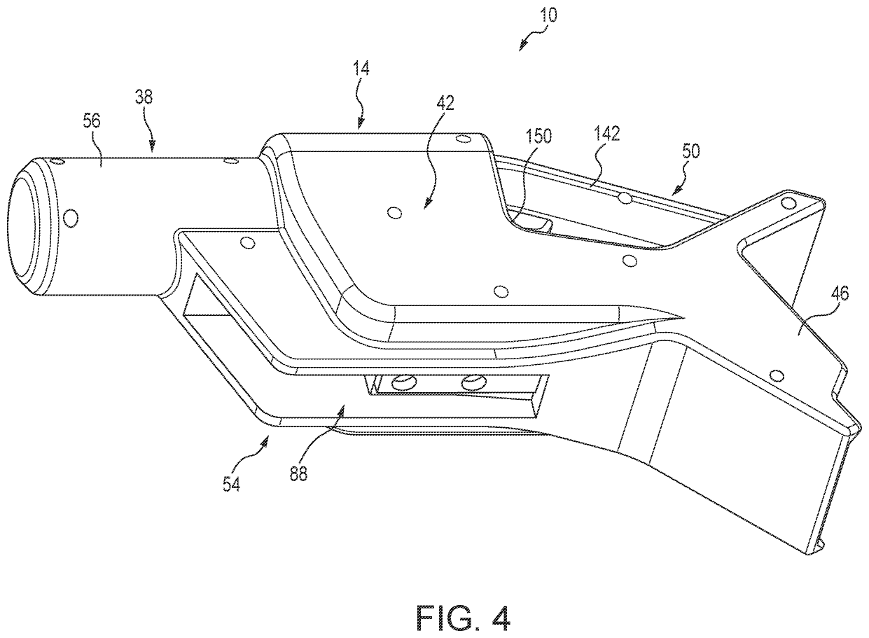

With reference to FIG. 4, the tool element interface 54 is adjacent the drive mechanism portion 42. The tool element interface 54 receives and supports the tool element 22, in the illustrated construction, a removable torque wrench cassette. Specifically, the tool element interface 54 includes a slot 88 for the tool element 22, and a retainer assembly 90 between the housing 14 and the tool element 22 operates to releasably retain the tool element 22 on the housing 14.

With reference to FIGS. 1, 2, and 5, the illustrated tool element 22 is a replaceable cassette removably coupled to the tool element interface 54. The tool element 22 may be a low-profile torque wrench cassette, such as, for example, a W-Series Hydraulic Torque Wrench Cassette, manufactured by Enerpac Tool Group Corp. The cassette 14 includes a main body 94, a drive element 98, and a drive plate or lever arm 102. The illustrated drive element 98 is a hex ratchet shaped and sized to receive and apply torque to a fastener (e.g., a nut N (see FIG. 5), a bolt, etc.) positioned on a flange F.

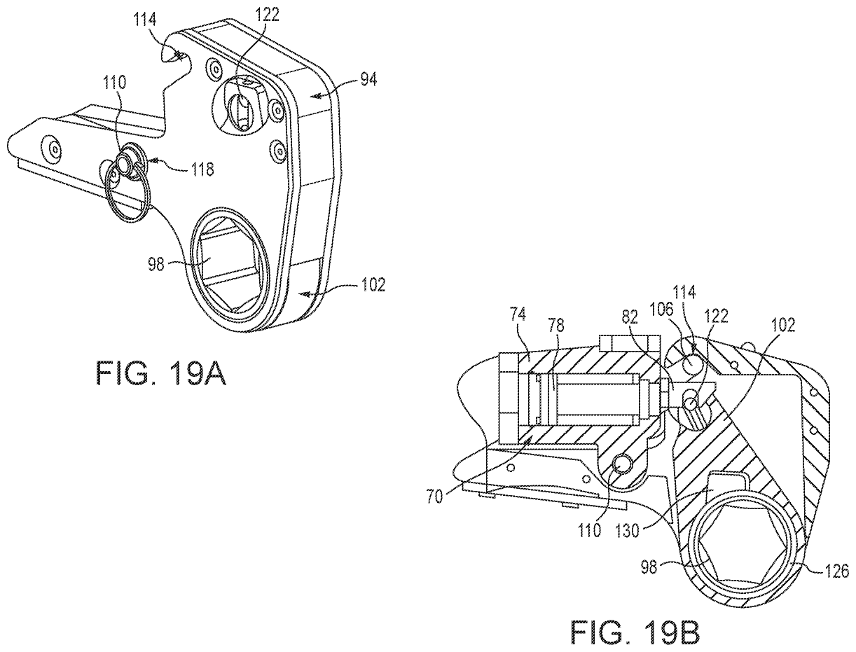

With reference to FIGS. 19A-19B, the retainer assembly 90 releasably couples the tool element 22 to the housing 14. In the illustrated embodiments, the retainer assembly 90 includes a fixed pin 106 and a removable pin 110 engageable in respective recesses 114, 118 in the main body 94, to therethrough releasably couple the tool element 22 to the housing 14. In other constructions (not shown), in addition or as an alternative to the pin(s) 126, 142, a different retainer assembly may be provided.

With continued reference to FIGS. 19A-19B, the driver 82 is coupled to the lever arm 102 (via a drive pin 122), which in turn engages a sprocket 126 by at least one pawl 130. The sprocket 126 is on an outer surface of the drive element 98.

When hydraulic pressure is applied to the piston and cylinder assembly 70 to extend the piston 78 and the driver 82, the lever arm 102 is driven to pivot in the first direction (e.g., clockwise in FIG. 19B). The pawl 130 engages the sprocket 126, thereby causing the sprocket 126 to rotate. Specifically, teeth of the pawl 130 engage complementary teeth of the sprocket 126 to rotate the sprocket 126 and, therethrough, the drive element 98 and the fastener (e.g., a nut N) engaged by the drive element 98. The lever arm 102 pivots through an angle of rotation as the piston 78 extends to its maximum stroke length. As the piston 78 retracts, the teeth of the pawl 130 slip past the teeth to the sprocket 126, thereby allowing the lever arm 102 to ratchet relative to the stationary drive element 98.

If worn, damaged, etc., the illustrated cassette may also be replaced by a comparable cassette. A different cassette (not shown) with a drive element having a different construction (e.g., a different size (metric, imperial, both) or interface shape (e.g., square)) may be substituted for the illustrated cassette. A different tool element (not shown) having a mounting interface complementary to the interface 48 and a drive arrangement compatible with the drive mechanism 18 may also be substituted for the illustrated cassette.

The battery pack interface 46 is adjacent the second end 14b of the housing 14 and removably supports the battery pack 30 (see FIGS. 1-2). As illustrated, the interface 40 is oriented to receive the battery pack 30 along an insertion axis 134 oriented obliquely relative to the longitudinal axis 34. Alternatively, the insertion axis 134 may be parallel or perpendicular to the longitudinal axis 34.

As mentioned above and as shown in FIGS. 1-2, the battery pack interface 46 supports the battery pack 30. In the illustrated embodiments, the battery pack 30 is a removable and rechargeable power tool battery pack and is operable to power electrical components (e.g., the motor 26, the user interface 138, etc.) of the torque wrench 10. The battery pack 30 may be connectable and operable to power various different power tools (e.g., as shown in FIG. 10, the hydraulic torque wrench 10, a hydraulic flange splitter, a driver, among others).

The illustrated battery pack 30 includes one or more battery cells arranged to provide a nominal voltage and capacity of the battery pack 30. For example, the battery pack 30 may be a 12-volt battery pack and may include three (3) Lithium-ion (Li-ion) battery cells. In other constructions, the battery pack 30 may include fewer or more battery cells arranged to have a different nominal voltage or capacity. The battery cells may have a chemistry other than Li-ion such as, for example, Nickel Cadmium (NiCd), Nickel Metal-Hydride (NiMH), etc.

The illustrated handle portion 50 is between the motor housing portion 38 and the battery pack interface 46. The handle portion 50 defines a gripping surface 142 graspable by the operator. The gripping surface 142 defines a second grip axis 146 oriented obliquely to the longitudinal axis 34 and to the first grip axis 60.

An actuator or trigger 150 for operating the torque wrench 10 is provided on the handle portion 50 and controls operation of the motor 26 and, thereby, operation of the hydraulic drive mechanism 18. Electronic control and monitoring circuitry (e.g., including an electronic processor (not shown)) are operable to control and/or monitor various functions and operations of the torque wrench 10.

A controller 152 (schematically illustrated in FIG. 6A), supported in the housing 14, is configured to control operation of the torque wrench 10 and its components. The controller 152 includes an electronic processor (not shown) mounted on a printed circuit board (PCB; not shown) providing a main control board (not shown) for the torque wrench 10. The main control board may be positioned in the motor housing portion 38. In other constructions (not shown), the control board may be positioned in other locations in the housing 14 based on factors such as weight (e.g., through material placement/removal), balance, ergonomics, fit, heat management, etc.

A motor driver control board (not shown) may be supported in the motor housing portion 38 and is in communication with the main control board. A heat sink (not shown) may be supported on the motor control board. Heat from the heat sink and the motor control board is vented through the vents in the motor housing portion 38 and away from the handle portion 50 and the operator.

The controller 152 is electrically and/or communicatively connected to a variety of modules or components of the torque wrench 10. The controller 152 includes a plurality of electrical and electronic components on the control board(s) that provide power, operational control, and protection to the components and modules within the controller 152 and/or the torque wrench 10. For example, the controller 152 includes, among other things, the electronic processor (a programmable electronic microprocessor, microcontroller, or similar device), a memory (not shown), and an input/output (I/O) interface (not shown). The electronic processor is communicatively coupled to the memory and the I/O interface.

The controller 152 may be implemented in several independent controllers each configured to perform specific functions or sub-functions. Additionally, the controller 152 may contain sub-modules that include additional electronic processors, memory, or application specific integrated circuits (ASICs) for handling communication functions, processing of signals, and application of the methods listed below. In other embodiments, the controller 152 includes additional, fewer, or different components.

The memory is, for example, a non-transitory, machine-readable memory. The memory includes, for example, one or more non-transitory machine-readable media, a program storage area, and a data storage area. The program storage area and the data storage area can include combinations of different types of memory, such as read-only memory (ROM) and random access memory (RAM). In some embodiments, data is stored in a non-volatile random-access memory (NVRAM) of the memory. Various non-transitory computer readable media, for example, magnetic, optical, physical, or electronic memory may be used.

In the illustrated embodiment, the memory includes an input controller engine (not shown; for example, software or a set of computer-readable instructions that determines functions to be executed in response to inputs) and torque multiplier functions (for example, software or a set of computer-readable instructions that provide functionality to the torque wrench 10).

The electronic processor is communicatively coupled to the memory and executes software instructions that are stored in the memory, or stored in another non-transitory computer readable medium such as another memory or a disc. The software may include one or more applications, program data, filters, rules, one or more program modules, and other executable instructions. In some embodiments, the memory stores predetermined functions that are executed to provide torque multiplier functionality within the program storage area.

The I/O interface is communicatively coupled to components external to the controller 152 and coordinates the communication of information between the electronic processor and other components of the puller 10. In illustrated examples, information received from an input component, an external device, etc. is provided to the electronic processor to assist in determining functions to be executed and outputs to be provided. The determined functionality is executed with the electronic processor with the software located the memory.

The torque wrench 10 may include one or more sensors 154 (e.g., a pressure gage (see FIG. 6A)) operable to sense a characteristic of the torque wrench 10. The sensors 154 may also include a motor sensor, a movement sensor, a temperature sensor, etc. The controller 152 is connected to and communicates with (e.g., receives measurement signals from) the sensor(s) 154.

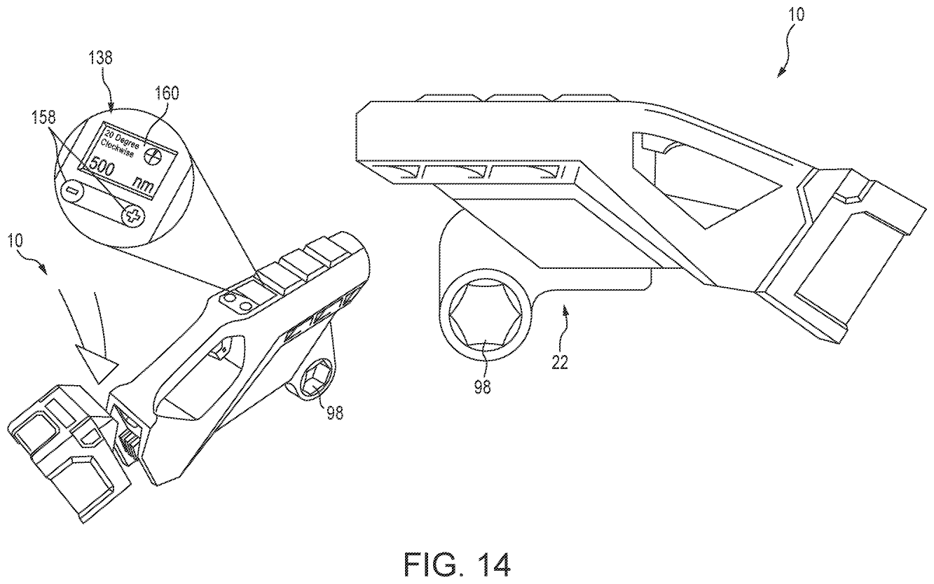

With reference to FIG. 14, a user interface device 138 is positioned on the housing 14 and is operable to communicate information and instructions to/from the operator. The illustrated user interface device 138 includes a user input device 158 (e.g., one or more buttons (two shown), keys, a touch screen, etc.) and a display 160 configured to display conditions or data associated with the torque wrench 10.

For example, the display 160 may be configured to display, in real-time or substantially real-time, a measured torque reading indicative of a torque applied to the fastener by the torque wrench 10 when activated. The display 160 is, for example, a liquid crystal display (“LCD”), a light-emitting diode (“LED”) display, an organic LED (“OLED”) display, an electroluminescent display (“ELD”), a surface-conduction electronemitter display (“SED”), a field emission display (“FED”), a thin-film transistor (“TFT”) LCD, etc.

As shown in FIG. 6A, the controller 152 is connected to and communicates with the control valve 83. While illustrated as a manual control valve, the control valve 83 may include a solenoid valve controlled by the controller 152 to control the flow of hydraulic fluid to the cylinder assembly 70, for example, based on instructions from the operator, based on information from the sensor(s) 154, etc. The controller 152 may also be connected to, communicate with, and/or control the adjustable relief valve 84.

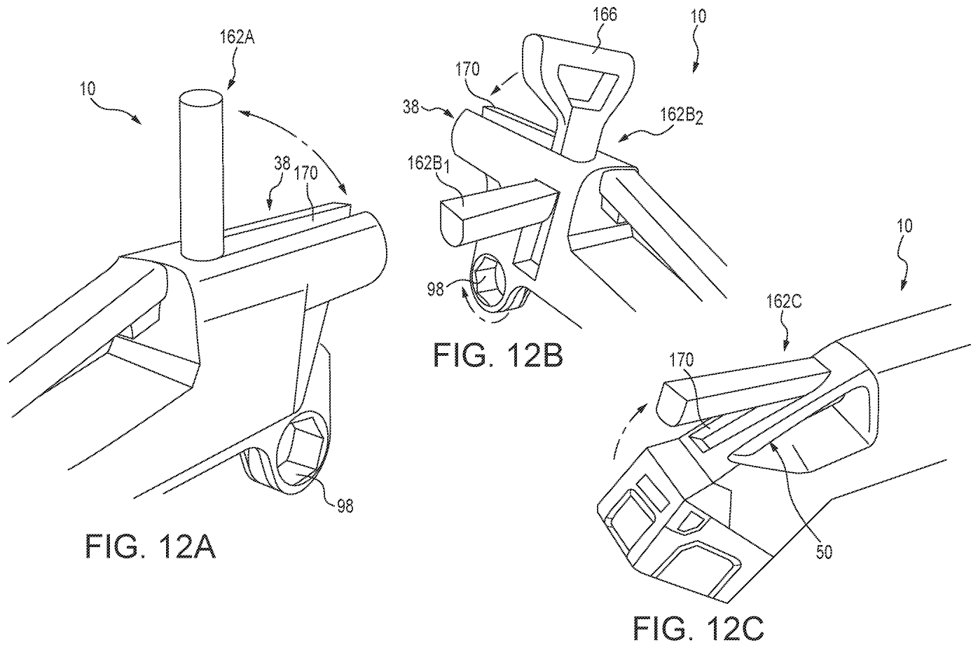

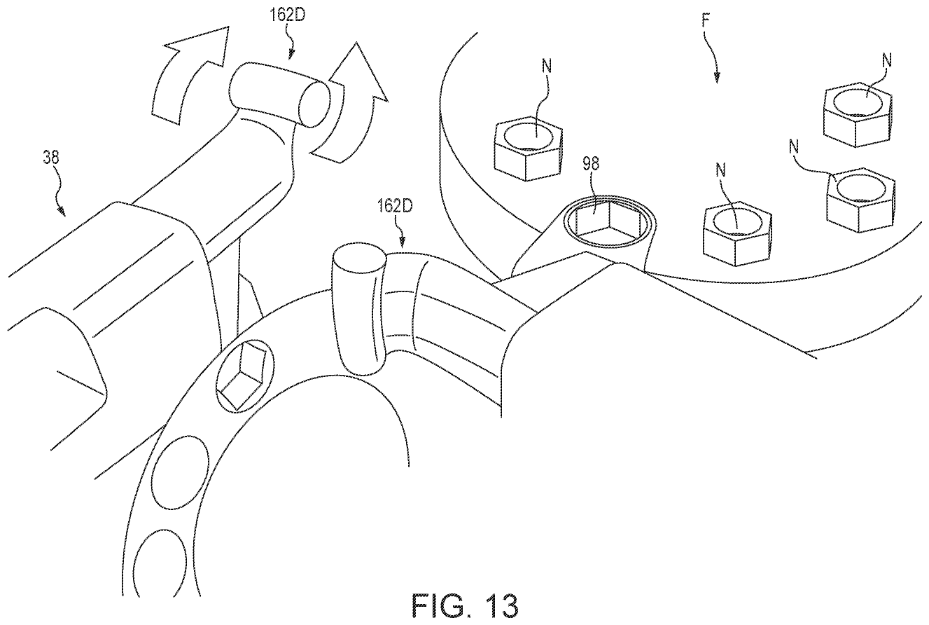

With reference to FIGS. 12A-13, in some embodiments, the torque wrench 10 may include a supplemental handle 162, which, as illustrated, may be movably coupled to the housing 14. The supplemental handle 162 defines a gripping portion 166 graspable by the operator, as an alternative to the gripping surface 56.

The illustrated supplemental handle 162 is movable (e.g., pivotable) between a stowed position, in which the supplemental handle 162 is stowed on the housing 14 (e.g., positioned in a groove 170 on the housing 14 to be flush with a surface of the housing 14), and at least one operating position, in which the supplemental handle 162 extends from the housing 14 to be engageable by an operator.

The supplemental handle 162 may be positioned at different locations along the housing 14. For example, as shown in FIGS. 12A-12C), a supplemental handle 162A, 162B, 162C is illustrated as being positioned on the motor housing portion 38, the drive mechanism portion 42, and the handle portion 50, respectively. In some constructions (see FIG. 12B), the torque wrench 10 may include more than one supplemental handle 162B1, 162B2.

The supplemental handle 162 may have various configurations. For example, the supplemental handle 162A, 162C may be generally cylindrical (FIG. 12A), rectangular (FIG. 12C), etc. With reference to FIG. 12B, the supplemental handle 162B2 may be a D-handle with a gripping portion 166 on a distal end. The illustrated gripping portion 166 is generally triangular and includes an aperture shaped and sized to receive the operator's hand during operation.

As another example (see FIG. 13), the supplemental handle 162D may protrude from the motor housing portion 38. As shown, the illustrated supplemental handle 162 is pivotable in upward and downward directions.

To use the torque wrench 10, the components are assembled for operation. The tool element 22 is installed and retained on the housing 14 and connected to the drive mechanism 18. A battery pack 30 with sufficient capacity and voltage is connected to the battery interface 40.

When positioning the torque wrench 10, the operator grasps the gripping surface 56 with one hand and the gripping surface 142 with the other hand. The relative positions, orientations, and/or constructions of the gripping surfaces 56, 70 on the housing 14 allow for the operator to operate the torque wrench 10 in a stable, comfortable and/or convenient manner. For example, because the gripping surface 56 is adjacent the first end 14a of the housing 14, and the gripping surface 142 is adjacent the second end 14b of the housing 14, the weight of the torque wrench 10 is evenly distributed when the operator grasps both gripping surfaces 56, 70.

The torque wrench 10 is oriented relative to and positioned on a workpiece (the flange F) with the drive element 98 engaging a fastener (nut N) in the selected drive direction (e.g., tightening) and another portion of the torque wrench 10 providing a reaction surface relative to the workpiece (e.g., a portion of the cassette housing 110 engaging an adjacent fastener (see FIG. 5)). The operator operates the trigger 150 to supply power from the battery pack 30 to the motor 26 to drive the pump 66. The pump 66 supplies hydraulic fluid to the piston and cylinder assembly 70 to reciprocate the piston 78 and the driver 82. The torque wrench cassette tool element 22 is thereby operated so that the drive element 98 applies torque to the fastener.

The torque wrench 10 is operated until the desired torque on the fastener is achieved. The torque wrench 10 is positioned on another fastener and the process is completed until the operation is completed (e.g., all fasteners on the flange F are tightened to the desired torque). As the torque wrench 10 is repositioned on the flange F, the operator is able to grasp the universal gripping surface 56.

Alternatively, to loosen the fastener, the torque wrench 10 can be flipped to engage the fastener from the other side of the drive element 98. The torque wrench 10 and the cassette tool element 22 are constructed to allow positioning of the torque wrench 10 on the flange F and the drive element 98 on the fasteners in either the tightening or loosening orientation.

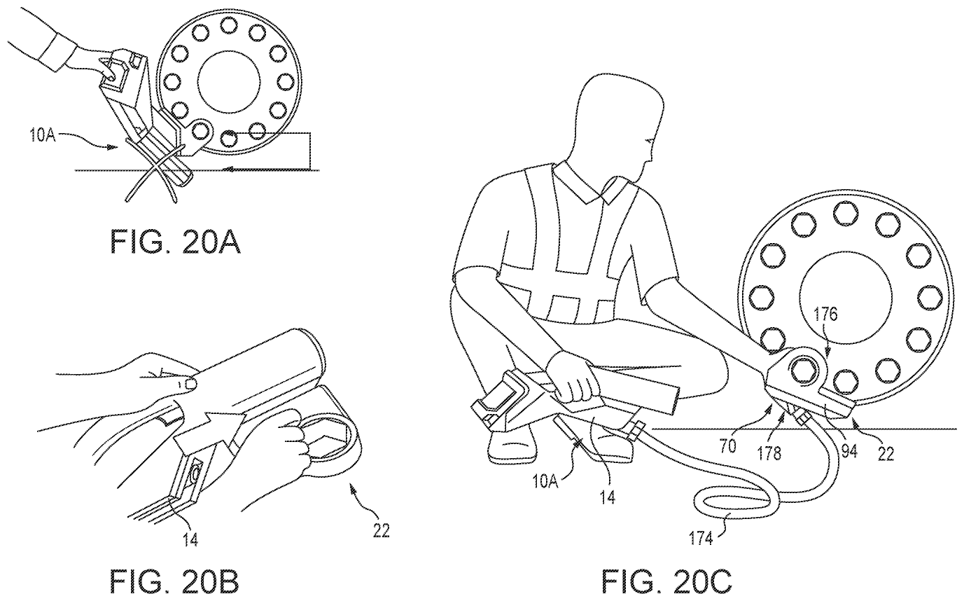

FIGS. 20A-20C illustrate another construction of a torque wrench 10A. The torque wrench 10A is similar to the torque wrench 10 described above and common elements have the same reference number.

The torque wrench 10A is operable in a first configuration (similar to that shown, for example, in FIG. 5) with the tool element 22 connected to and supported by the housing 14. As illustrated in FIG. 20C, the torque wrench 10A is also operable in a second configuration with the tool element 22 separate from the housing 14 and in fluid communication with the pump 66 through a conduit or hose 174. The tool element 22 may be removed, for example, to operate in places with limited access (see FIGS. 20A and 20C).

In the illustrated construction, the cylinder assembly 70 is incorporated with the tool element 22 and supported on its main body 94 to provide a hydraulic reaction arm assembly 176. The remainder of the torque wrench 10A acts as a hand-held, battery-powered hydraulic pump assembly, with the housing 14 supporting the motor 26, the pump 66, and the power source.

When assembled to the housing 14, the cylinder assembly 70 may directly fluidly connect to a port (not shown) of the hydraulic circuit connected to the pump 66. When removed from the housing 14, a separate hose 174 is connected between the port of the hydraulic circuit in the housing 14 and a port 178 of the cylinder assembly 70 on the tool element 22. Hoses 174 of different constructions (e.g., different lengths) may be used as necessary. In other constructions (not shown), the hose 174 may be fixed between the hydraulic circuit port and the cylinder assembly port 178, with the hose 174 being stored in the housing 14 in the assembled condition.

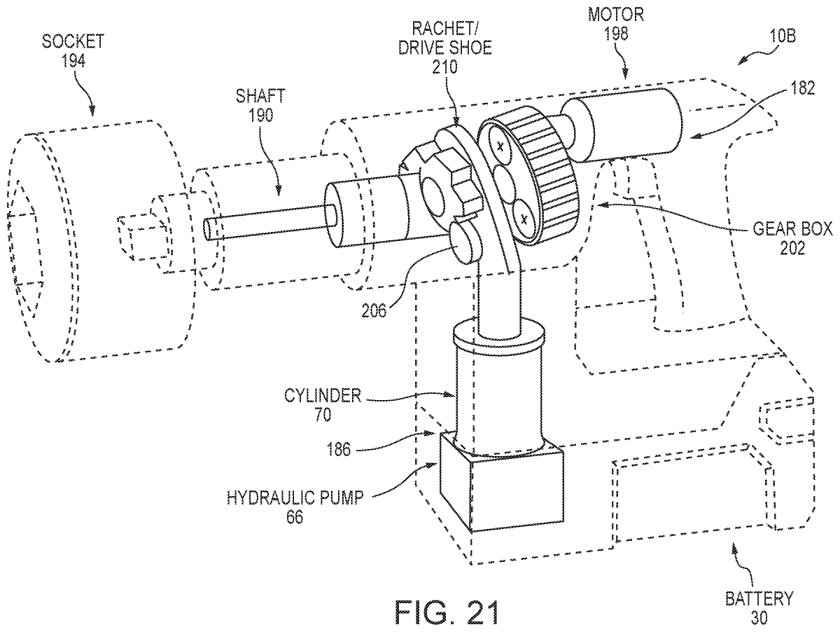

FIG. 21 illustrates another construction of a hydraulic torque wrench 10B. The torque wrench 10B is similar to the torque wrench 10, 10A described above and common elements have the same reference number.

The illustrated torque wrench 10B includes two drive mechanisms—a gear drive mechanism 182 and a hydraulic drive mechanism 186, similar to the hydraulic drive mechanism 18—each operable to selectively drive an output shaft 190 supporting a tool element (e.g., a socket 194).

The gear drive mechanism 182 includes an electric motor 198 powered by a battery pack 30 and operable to drive a gear box 202 (e.g., a planetary gear box) with an output connected to the output shaft 190. The gear drive mechanism 182 is operable to drive the socket 194 up to a first torque to quickly drive down the fastener to the first torque.

The hydraulic drive mechanism 186 is operable to drive the socket 194 above the first torque. The hydraulic drive mechanism 186 includes the pump 66 driven by an electric motor (e.g., the motor 198 or a separate motor (not shown)) and the cylinder assembly 70. The piston 78 is connected to and reciprocatingly drives a drive plate or lever arm 206. The lever arm 206 is connected by a ratchet mechanism (not shown) to a drive shoe 210, and the drive shoe 210 is operable to selectively apply torque to the output shaft 190.

In operation, when the piston 78 extends, the lever arm 206 pivots the drive shoe 210 in a driving direction to pivot the output shaft 190. When the piston 78 is retracted, the ratchet mechanism allows the lever arm 206 to pivot in a direction opposite to the driving direction relative to the drive shoe 210 and the output shaft 190.

Operation of the gear drive mechanism 182 and the hydraulic drive mechanism 186 may be controlled manually by the operator (e.g., through an input device (not shown)) and/or by a controller (not shown but similar to the controller 152) based on inputs from the operator, one or more sensors, such as a torque sensor (not shown), etc. When one drive mechanism (e.g., the gear drive mechanism 182) is driving the output shaft 190, the other drive mechanism (e.g., the hydraulic drive mechanism 186) is drivingly disconnected from the output shaft 190, for example, by a clutch mechanism (not shown). A clutch mechanism is provided to selectively drivingly connect and disconnect each drive mechanism 182, 186 and the output shaft 190.

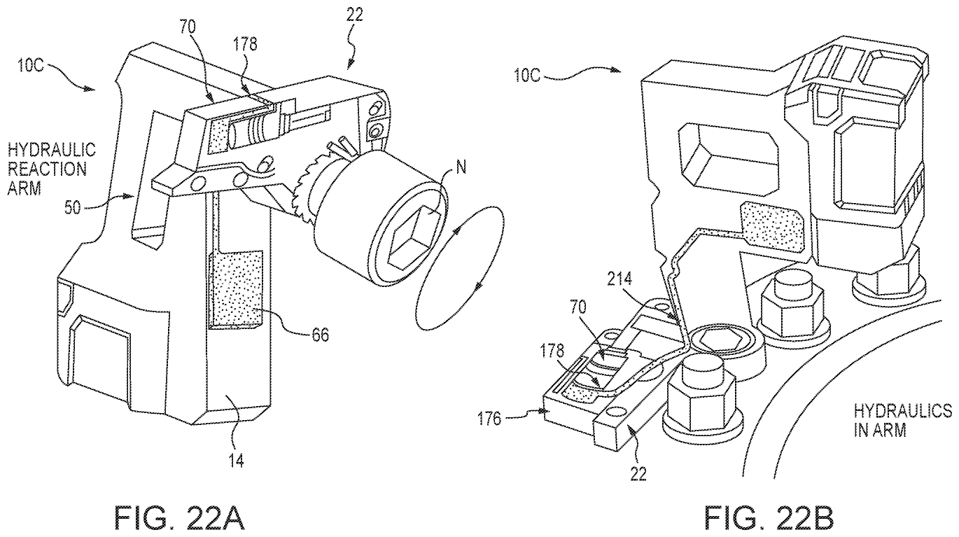

FIGS. 22A-22B illustrate another construction of a hydraulic torque wrench 10C. The torque wrench 10C is similar to the torque wrench 10, 10A, 10B described above and common elements have the same reference number.

As illustrated, the torque wrench 10C includes a hydraulic reaction arm assembly 176, with a tool element 22 having an incorporated cylinder assembly 70, and a separate hand-held, battery-powered hydraulic pump assembly, with the housing 14 (providing a D-handle portion 50) supporting the motor (not shown but similar to the motor 26), the pump 66, and the power source. The pump 66 outputs hydraulic fluid at a pressure to a port 214 on the housing 14. When supported on the housing 14, the port 178 of the cylinder assembly 70 fluidly connects to the port 214.

FIG. 22B illustrates the torque wrench 10C in use to adjust a fastener (e.g., a nut N) on a flange F. The tool element 22 includes a square drive. In FIG. 22B, the reaction arm assembly 176 is supported on the housing 14 in one orientation to apply torque to the fastener in one direction (e.g., a tightening direction). In another orientation (not shown), the reaction arm assembly 176 is reversed on the housing 14 to apply torque to the fastener in the opposite direction (e.g., a loosening direction). In each orientation, the ports 178, 214 are fluidly connected.

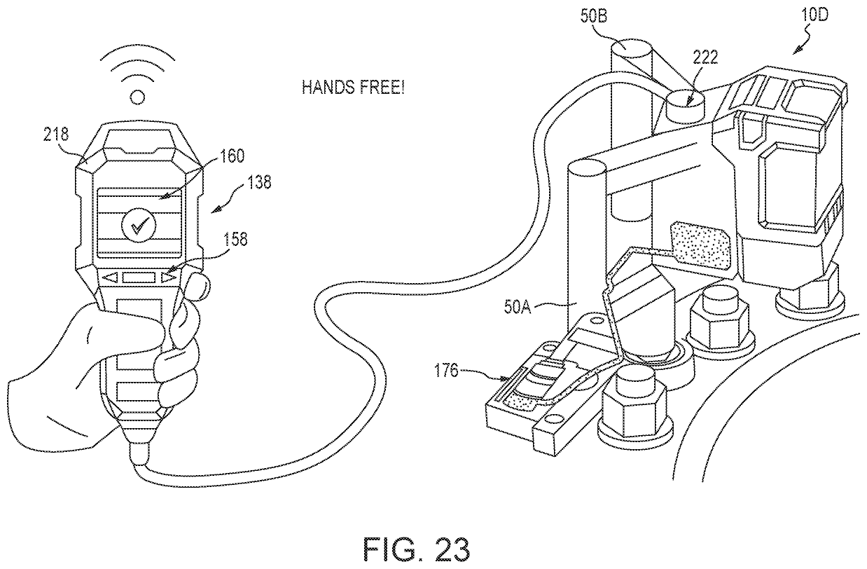

FIG. 23 illustrates another construction of a hydraulic torque wrench 10D. The torque wrench 10D is similar to the torque wrench 10, 10A, 10B, 10C described above and common elements have the same reference number.

As illustrated, the torque wrench 10D includes a hydraulic reaction arm assembly 176, with a tool element 22 having an incorporated cylinder assembly 70, and a separate hand-held, battery-powered hydraulic pump assembly, with the housing 14 supporting the motor (not shown but similar to the motor 26), the pump 66, and the power source.

The reaction arm assembly 176 is supported on the housing 14 in opposite orientations to apply torque to the fastener in respective opposite directions (e.g., a tightening direction (as shown in FIG. 23) and an opposite loosening direction (not shown)). In each orientation, the ports 178, 214 are fluidly connected.

Rather than the traditional handle arrangement of the torque wrench 10, 10A, 10B, 10C, similar to a hand-held power tool, the housing 14 of the torque wrench 10D provides handle portions 50A, 50B. The handle portions 50A, 50B are engaged by the operator for example, for transport, positioning, etc., of the torque wrench 10D rather than to support of the torque wrench 10D during use.

As shown in FIG. 23, operation of the torque wrench 10D may be controlled by a remote device (e.g., a wireless or wired pendant 218). In illustrated construction, the torque wrench 10D includes a controller area network (CAN) bus 222 configured for wired communication with the pendant 218. The pendant 218 is configured to control operation of the torque wrench 10D. With the pendant 218, the operator is able to be spaced away from the workpiece. A wrap (not shown) may be provided for the cord of the pendant 218. The housing 14 may also include a receptacle (not shown) sized to receive and retain the pendant 218, such that the pendant 218 can stored with the torque wrench 10D.

The pendant 218 includes a user interface device 138 with a user input device 158 (e.g., one or more buttons, keys, a touch screen, etc.) configured to receive one or more inputs (e.g., a selection, a command, etc.) from an operator. The inputs are communicated to the controller 152 to execute selected torque wrench functions and/or operations.

The pendant 218 also includes a user feedback or output device (e.g., a display 160)) configured to display conditions or data associated with the torque wrench 10D. The controller 152 communicates with and controls the output to the operator (e.g., the condition(s) presented on the display). For example, the display may be configured to display, in real-time or substantially real-time, a torque, a fluid pressure, the capacity of the battery pack 30, etc.

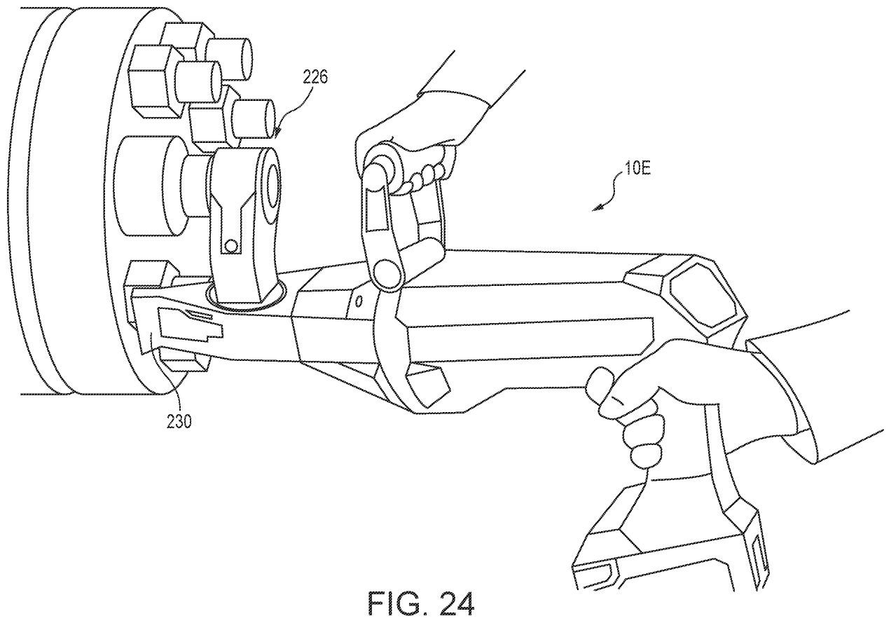

FIG. 24 illustrates another construction of a hydraulic torque wrench 10E. The torque wrench 10E is similar to the torque wrench 10, 10A, 10B, 10C, 10D described above and common elements have the same reference number.

In the illustrated construction, the cylinder assembly 70 is incorporated with the tool element 22 and supported on its main body 94 to provide a hydraulic drive assembly 226. The remainder of the torque wrench 10E acts as a hand-held, battery-powered hydraulic pump assembly, with the housing 14 supporting the motor 26, the pump 66, and the power source. The housing 14 also includes a reaction member 230 engageable to provide a reaction force during torquing operations.

When assembled to the housing 14, a port (not shown) of the cylinder assembly 70 may directly fluidly connect to a port (not shown) of the hydraulic circuit connected to the pump 66. The hydraulic drive assembly 226 is supported on the housing 14 in opposite orientations to apply torque to the fastener in respective opposite directions (e.g., a tightening direction (as shown in FIG. 24) and an opposite loosening direction (not shown)). In each orientation, the ports of the hydraulic circuit and the cylinder assembly 70 are fluidly connected.

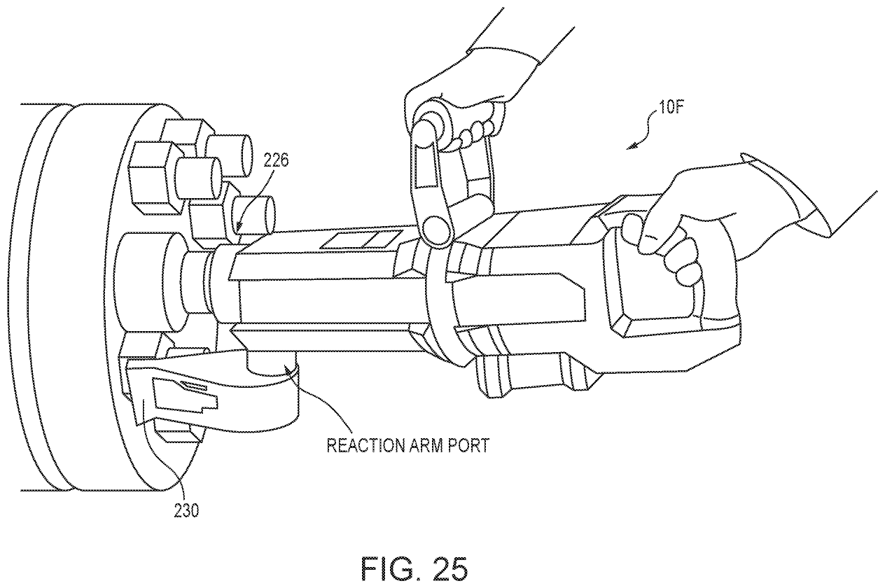

FIG. 25 illustrates another construction of a hydraulic torque wrench 10F. The torque wrench 10F is similar to the torque wrench 10, 10A, 10B, 10C, 10D, 10E described above and common elements have the same reference number.

In the illustrated construction, the cylinder assembly 70 is incorporated with the tool element 22 and supported on its main body 94 to provide a hydraulic drive assembly 226. The remainder of the torque wrench 10F acts as a hand-held, battery-powered hydraulic pump assembly, with the housing 14 supporting the motor 26, the pump 66, and the power source. The reaction member 230 is supportable on the hydraulic drive assembly 226 or on the housing 14 and is engageable to provide a reaction force during torquing operations.

When assembled to the housing 14, a port (not shown) of the cylinder assembly 70 may directly fluidly connect to a port (not shown) of the hydraulic circuit connected to the pump 66. The hydraulic drive assembly 226 is supported on the housing 14 in opposite orientations to apply torque to the fastener in respective opposite directions (e.g., a tightening direction (as shown in FIG. 24) and an opposite loosening direction (not shown)). In each orientation, the ports of the hydraulic circuit and the cylinder assembly 70 are fluidly connected.

In contrast to operation of conventional hydraulic torque wrenches using a separate pump which require two operators, only one operator is needed for the torque wrench 10 with its onboard hydraulic drive mechanism 18 and power source (battery pack 30). The onboard hydraulic drive mechanism 18 and the onboard battery pack 30 allows an operator to conveniently transport the torque wrench 10 to/from and around a work area and to operate the torque wrench 10 in work area with limited access to electrical power and/or pneumatics.

The dual gripping surfaces (e.g., the gripping surface 56, the gripping surface 142, and/or the supplemental handle 162) allow for a single operator to support the torque wrench 10 in a stable, comfortable and/or convenient manner.

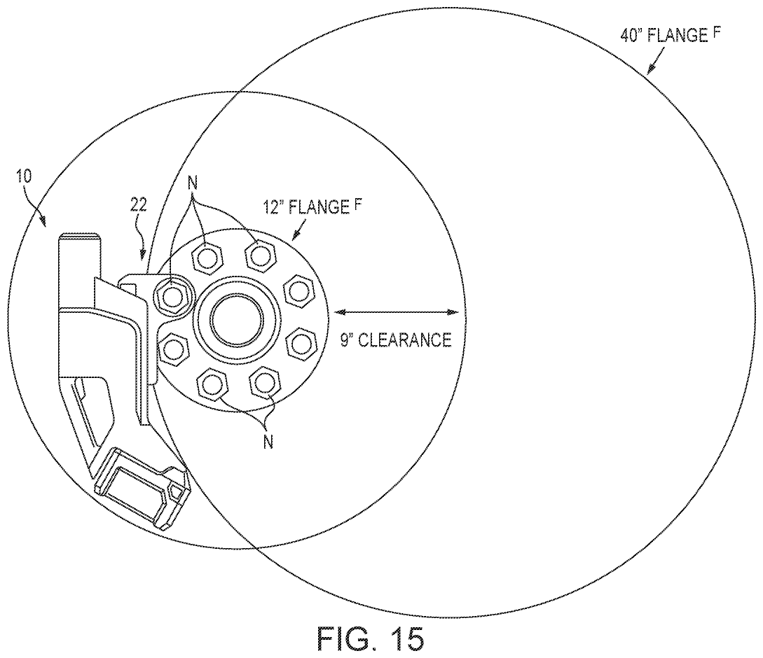

With reference to FIG. 15, the compact shape and size of the torque wrench 10, including the orientation and positioning of the battery pack 30 on the interface 40, allows the torque wrench 10 to be used on work surfaces (e.g., flanges F) of various shapes and sizes. For example, the torque wrench 10 may be used on a 12″ flange F (within a clearance of about 9″ relative to obstructions around the flange F) and a 40″ flange (within a clearance of about 6.5″).

It should be understood that, in other constructions (not shown), one or more features of a torque wrench 10, 10A, 10B, 10C, 10D, 10E, 10F may be incorporated into, substituted for, replaced by, etc. one or more features of another torque wrench 10, 10A, 10B, 10C, 10D, 10E, 10F, and vice versa.

One or more independent features and/or independent advantages of the invention may be set forth in the claims.

1. A hydraulic torque wrench comprising:
a housing including a handle portion engageable by an operator;
a motor positioned in the housing;
a battery pack supported on the housing and operable to supply power to the motor;
a pump supported by the housing and powered by the motor;
a piston-cylinder assembly including
a cylinder,
a piston movably supported in the cylinder, and
a driver attached to the piston and movable therewith between a retracted position and an extended position, the pump being operable to transfer hydraulic fluid to the cylinder to move the piston; and
a drive element coupled to the driver, the driver being configured to transmit torque through the drive element.

2. The wrench of claim 1, further comprising a cassette removably coupled to the housing, the cassette including the drive element.

3. The wrench of claim 2, wherein the cassette includes a cassette housing supporting the drive element, and wherein the housing defines a slot for receiving a portion of the cassette housing.

4. The wrench of claim 2, further comprising a retainer assembly operable to releasably retain the cassette on the housing.

5. The wrench of claim 2, wherein the cassette includes a ratchet arm driven by the driver, and
a ratchet mechanism between the ratchet arm and the drive element.

6. The wrench of claim 2, wherein the piston-cylinder assembly is supported by the cassette housing.

7.-9. (canceled)

10. A hydraulic tool comprising:
a housing having a first end and a second end, the housing including
a motor housing portion positioned on the first end and providing a first grip engageable by a hand of an operator defining a first grip axis, and
a handle engageable by another hand of the operator and defining a second grip axis obliquely oriented relative to the first grip axis;
a piston and cylinder assembly;
a pump supported by the housing and operable to transfer hydraulic fluid to the piston and cylinder assembly;
a motor positioned in the motor housing portion and configured to drive the pump; and
a tool element coupled to the housing and including a drive element coupled to the piston and cylinder assembly, the piston and cylinder assembly being configured to transmit torque through the drive element.

11. The tool of claim 10, wherein the drive element is a torque wrench drive element, the tool element includes a torque wrench cassette supportable by the housing, the housing includes a tool element interface operable to removably support the cassette, and the piston and cylinder assembly is supported by the cassette.

12.-14. (canceled)

15. The tool of claim 10, wherein the housing includes a pump housing portion between the motor housing portion and the handle, the pump being supported in the pump housing portion, and further comprising a battery pack supported on the housing and operable to supply power to the motor.

16. (canceled)

17. The tool of claim 15, wherein the housing further including a battery pack support portion proximate the second end, the battery pack being supportable on the battery pack support portion.

18. (canceled)

19. (canceled)

20. A hydraulic tool comprising:
a housing having a first end, a second end, and a longitudinal axis extending through the first end and the second end, the housing including
a handle engageable by a hand of an operator and defining a grip axis obliquely oriented relative to the longitudinal axis, and
a battery pack support portion proximate the second end;
a battery pack supported on the battery pack support portion along a battery insertion axis the battery insertion axis being obliquely oriented relative to the longitudinal axis and the grip axis;
a piston and cylinder assembly;
a pump supported by the housing and operable to transfer hydraulic fluid to the piston and cylinder assembly;
a motor positioned adjacent the first end and configured to drive the pump; and
a tool element coupled to the housing and including a drive element coupled to the piston and cylinder assembly, the piston and cylinder assembly being configured to transmit torque through the drive element.

21. The tool of claim 20, wherein the drive element is a torque wrench drive element, the tool element includes a torque wrench cassette supportable by the housing, and the housing includes a tool element interface operable to removably support the cassette.

22.-23. (canceled)

24. The tool of claim 23, wherein the piston and cylinder assembly is supported by the cassette.

25. The tool of claim 20, wherein the housing includes a pump housing portion between the first end and the handle, the pump being supported in the pump housing portion.

26. The tool of claim 20, further comprising a trigger supported on the handle and operable to control operation of the motor.

27. The tool of claim 20, wherein the housing includes a motor housing portion positioned on the first end, the motor being supported in the motor housing portion, the motor housing portion providing a grip engageable by another hand of the operator, wherein the grip defines a second grip axis, the second grip axis being parallel to or coaxial with the longitudinal axis.

28.-29. (canceled)

30. A method of operating a hydraulic tool, the tool including a housing providing a handle engageable by an operator, a power source supported by the housing, a motor positioned in the housing and powered by the power source, a pump positioned in the housing and driven by the motor, a piston and cylinder assembly, and a tool element including a drive element, the method comprising:
supporting the tool element on the housing;
with the tool element supported on the housing,
engaging the tool element with a workpiece, and
operating the pump to transfer hydraulic fluid to the piston and cylinder assembly to thereby transmit force through the drive element to the workpiece;
disengaging the tool element from the housing; and
with the tool element disengaged from the housing,
engaging the tool element with a workpiece, and
operating the pump to transfer hydraulic fluid to the piston and cylinder assembly to thereby transmit force through the drive element to the workpiece.

31. The method of claim 30,
wherein the piston and cylinder assembly is supported by the tool element, and wherein the method further comprises fluidly connecting the pump and the piston and cylinder assembly;
wherein fluidly connecting includes fluidly connecting the pump and the piston and cylinder assembly when the tool element is supported on the housing and when the tool element is disengaged from the housing;
wherein, when the tool element is disengaged from the housing, fluidly connecting includes connecting a hose between the pump and the piston and cylinder assembly.

32.-33. (canceled)

34. A method of operating a hydraulic torque wrench, the torque wrench including a housing providing a handle engageable by an operator, a power source supported by the housing, a motor positioned in the housing and powered by the power source, a pump positioned in the housing and driven by the motor, and a hydraulic drive assembly including a piston and cylinder assembly and a tool element including a drive element, the method comprising:
supporting the hydraulic drive assembly on the housing in a first orientation;
with the hydraulic drive assembly in the first orientation,
engaging the tool element with a workpiece, and
operating the pump to transfer hydraulic fluid to the piston and cylinder assembly to thereby transmit torque through the drive element in a first direction to the workpiece;
supporting the hydraulic drive assembly on the housing in a different second orientation; and
with the hydraulic drive assembly in the second orientation,
engaging the tool element with a workpiece, and
operating the pump to transfer hydraulic fluid to the piston and cylinder assembly to thereby transmit force through the drive element in an opposite second direction to the workpiece.

35. (canceled)

36. The method of claim 34, wherein supporting the hydraulic drive assembly on the housing in a first orientation includes fluidly connecting the pump and the piston and cylinder assembly, and wherein supporting the hydraulic drive assembly on the housing in a second orientation includes fluidly connecting the pump and the piston and cylinder assembly.

37.-38. (canceled)
